(19) United States
(12) Patent Application Publication
(10) Pub. No.: US 2014/0004940 A1
(43) Pub. Date: Jan. 2, 2014

(54) Providing Recreation and Social Activities in Retail Environments

(71) Applicants: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(21) Appl. No.: 13/710,227

(22) Filed: Dec. 10, 2012

Related U.S. Application Data
(60) Provisional application No. 61/569,115, filed on Dec. 9, 2011.

(51) Int. Cl. A63F 13/00

(52) U.S. Cl. CPC A63F 13/00
USPC 463/31

(57) ABSTRACT

The present invention is generally directed to providing recreational activities or social interactions within a retail store. The recreational activities or social interactions can create a fun, spontaneous, and exciting atmosphere which may increase store interest or consumer loyalty. The recreational activities or social interactions can be provided on a display device such as a customer's mobile phone, or a stationary display attached to a shelf or other structure.

### CROSS-REFERENCE TO RELATED APPLICATIONS

This application claims priority to U.S. Provisional Patent Application No. 61/569,115 which was filed on Dec. 9, 2011 and titled “Providing Recreation And Social Activities In Retail Environments.”

### BACKGROUND

Manufactures and merchants both employ a wide variety of advertising techniques to attract and entice customers to purchase items that are stored and displayed on shelves. Because the shelf is often the last decision point in a buying decision, the ability to influence a customer's last decisive moments before the customer leaves the shelf often depends on the ability of the display to catch the customer's attention.

Currently, there are several ways in which manufactures and merchants try to catch a customer's attention at the point of purchase. For example, some manufactures and merchants place static advertisements in close proximity to a target product. These static advertisements often rely on artistry, color, advertised price, or shelf location to attract customers. Many customers tend to overlook these advertisements as commonplace objects. Thus, static advertisements frequently fail to catch a customer's attention. In an effort to be more effective, some static advertisements incorporate blinking lights with their otherwise static displays.

Manufacturers and merchants also use dynamic displays (e.g. video or audio displays). Oftentimes, these dynamic displays make navigating an aisle more difficult. Similarly, such displays may also become damaged, tattered, or unattractive. Displays are often overused, such as by being placed to close together, which minimizes the effectiveness of each display.

### BRIEF SUMMARY

The present invention extends to methods, systems, and computer program products for providing recreational activities or social interactions within a retail store. The recreational activities or social interactions can create a fun, spontaneous, and exciting atmosphere which may increase store interest or consumer loyalty. The recreational activities or social interactions can be provided on a display device such as a customer's mobile phone, or a stationary display attached to a shelf or other structure.

In one embodiment, the present invention provides a method for providing a game within a map of a retail store to provide entertainment to the customer while shopping in the retail store. The portable computing device determines that the customer is located at a retail store. A map of the retail store is generated. The map includes a game that the customer interacts with while shopping in the retail store. The map of the retail store is displayed to the customer such that the customer can interact with the game. Input is received from the customer that interacts with the game. In response to the input, the game is updated within the map.

In another embodiment, the present invention provides a method for providing a game within a map of a retail store to provide entertainment to the customer while shopping in the retail store. It is detected that a portable computing device carried by a customer is located at a retail store. A map of the retail store is sent to the portable computing device for display to the customer. The map includes a game that the customer interacts with while shopping in the retail store. Customer input that interacts with the game is received from the portable computing device. In response to the customer input, the game is updated within the map.

In another embodiment, the present invention provides a method for providing a game to a customer while the customer is at a retail store. It is determined that a customer is located at a retail store. A game is displayed on a display device. The game is associated with an activity that the customer performs at the retail store, and comprises a challenge to perform the activity in accordance with specified criteria. The customer's performance of the activity is tracked. A reward is provided to the customer for performing the activity in accordance with the specified criteria.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary environment in which the present invention can be implemented;

FIGS. 2A-2C illustrate an exemplary customer computing device that provides a user interface for displaying a game to a customer while at a retail store;

FIG. 3 illustrates an exemplary method for providing a game within a map of a retail store to provide entertainment to the customer while shopping in the retail store;

FIG. 4 illustrates an exemplary method for providing a game within a map of a retail store to provide entertainment to the customer while shopping in the retail store; and

FIG. 5 illustrates an exemplary method for providing a game to a customer while the customer is at a retail store.

### DETAILED DESCRIPTION

The present invention extends to methods, systems, and computer program products for providing recreational activities or social interactions within a retail store. The recreational activities or social interactions can create a fun, spontaneous, and exciting atmosphere which may increase store interest or consumer loyalty. The recreational activities or social interactions can be provided on a display device such as a customer's mobile phone, or a stationary display attached to a shelf or other structure.

In one embodiment, the present invention provides a method for providing a game within a map of a retail store to provide entertainment to the customer while shopping in the retail store. The portable computing device determines that the customer is located at a retail store. A map of the retail store is generated. The map includes a game that the customer interacts with while shopping in the retail store. The map of the retail store is displayed to the customer such that the customer can interact with the game. Input is received from the customer that interacts with the game. In response to the input, the game is updated within the map.

In another embodiment, the present invention provides a method for providing a game within a map of a retail store to provide entertainment to the customer while shopping in the retail store. It is detected that a portable computing device carried by a customer is located at a retail store. A map of the retail store is sent to the portable computing device for display to the customer. The map includes a game that the customer interacts with while shopping in the retail store. Customer input that interacts with the game is received from the portable computing device. In response to the customer input, the game is updated within the map.

In another embodiment, the present invention provides a method for providing a game to a customer while the customer is at a retail store. It is determined that a customer is located at a retail store. A game is displayed on a display device. The game is associated with an activity that the customer performs at the retail store, and comprises a challenge to perform the activity in accordance with specified criteria. The customer's performance of the activity is tracked. A reward is provided to the customer for performing the activity in accordance with the specified criteria.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

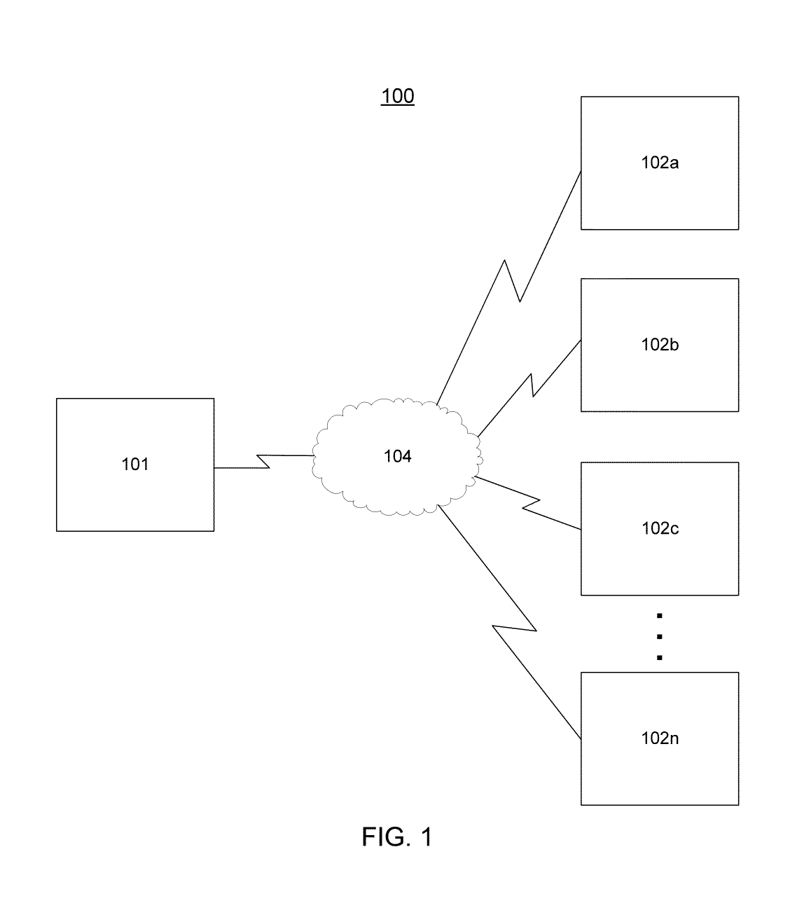

FIG. 1 illustrates an exemplary computer environment 100 in which the present invention can be implemented. Computer environment 100 includes server system 101, and computing devices 102a-102n. Computing devices 102a-102n can access content provided by server system 101 via network 103.

Server system 101 can comprise any number and type of computing devices or components. For example, server system 101 can comprise a single server device or a plurality of interconnected server components forming a cloud.

Computing devices 102a-102n can be any of various types of devices that can display a user interface and communicate with (i.e. send information to and/or receive information from) server system 101 (e.g. via Wi-Fi, Bluetooth, NFC, RFID, etc.). For example, a computing device can be a tablet, smart phone, or gaming device carried by a customer, or a stationary display device within a retail store.

Network 103 can represent various types of networks such as the internet, a local area network within a retail location, or any other type of network that allows content to be transferred from server system 101 to customer computing devices 102a-102n.

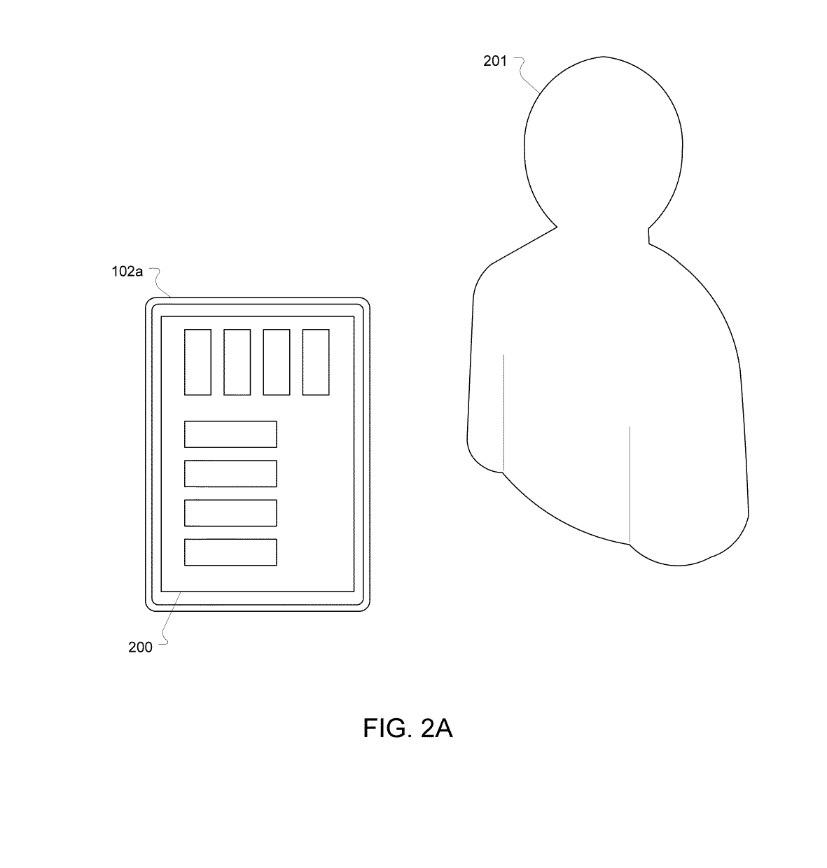

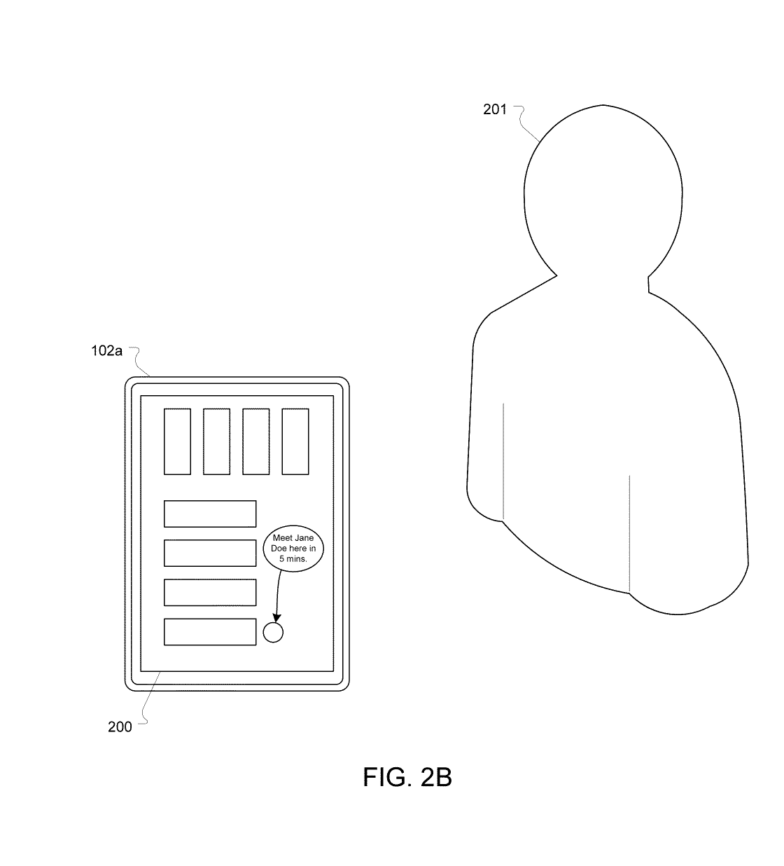

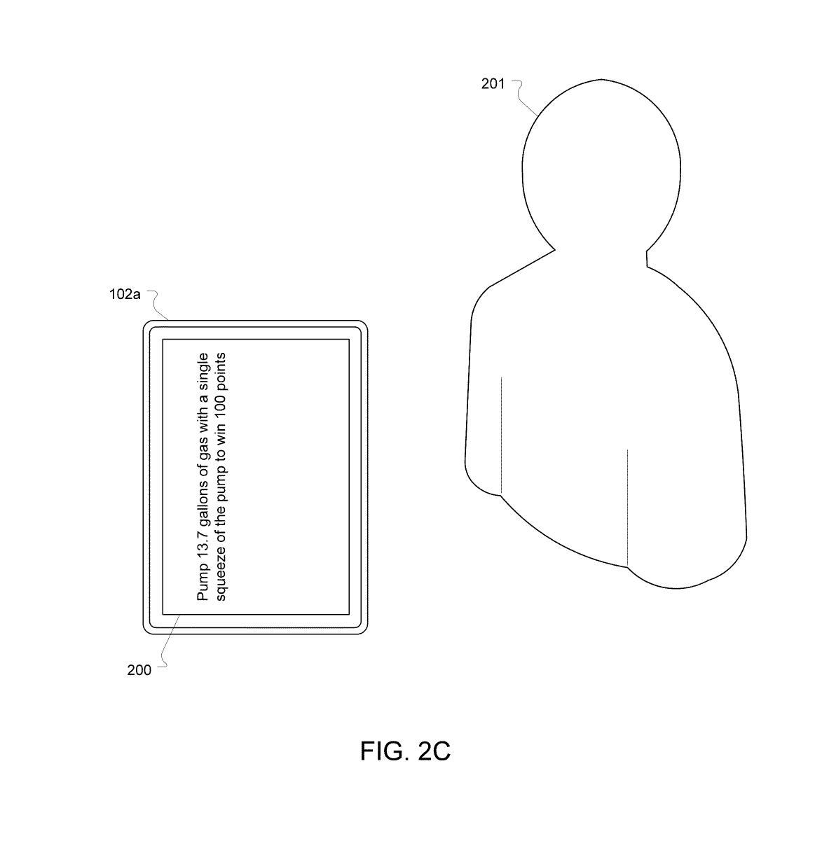

FIG. 2A illustrates an exemplary computing device 102a that provides a user interface 200 that can be displayed to a customer 201. User interface 200 can provide incentives to customer 201 as the customer follows a certain path within the store. For example, as shown in FIG. 2A, a map of the store can be presented in a game-type user interface. The customer's current position can be identified within the map and updated as the customer moves through the store. A customer can be encouraged to visit certain areas of a store by displaying challenges when the customer reaches the certain area. For example, user interface 200 can represent customer 201 as a warrior and display various villains in areas of the store. When the customer 201 moves to an area containing a villain, user interface 200 can display a battle scene where the warrior battles with the villain to earn a reward.

Other types of incentives can be provided on the map that can introduce the customer to various parts of the store, advertisements, store features, etc. For example, user interface 200 can provide a game where points are earned for visiting certain areas of the store, for travelling a particular route, or for stopping to view certain products or advertisements. Also, user interface 200 can also assist customers in finding products by identifying the location of a product on the map.

In some embodiments, user interface 200 can identify or reinforce particular customer behaviors by providing a cue, such as audio or visual output, when a shopping achievement is accomplished. Such cues can be included with games or other activities. For example, user interface 200 can output a sound when a shopping achievement is unlocked. An example of a shopping achievement can include successfully buying a certain number or type of goods within a certain amount of time, being a loyal shopper, or earning a coupon based on shopping history.

For example, an audible cheer could be played over a checkout counter when a shopper purchases a tenth gallon of milk over a given period of time. In another example, the sound of coins dropping into a piggybank can sound over an aisle where a customer picks up a certain product that is on sale. In yet another example, a heroic or victorious sound may be played over a pharmacy checkout location when a customer's loyalty card is scanned.

In some embodiments, activities or interactions can be coordinated among a plurality of computing devices. For example, a mini flash mob around a particular product can be announced on a mobile device of various customers in the store. The announcement can be provided to each customer that is determined to potentially be interested in a particular product (e.g. based on purchase history, preferences, profile, etc.). Participants in the flash mob can receive a reward, such as loyalty points or coupons).

In some embodiments, user interface 200 is configured to facilitate social introductions between customers. For example, as shown in FIG. 2B, based on criteria such as common purchasing behaviors, preferences, or demographics of two customers, user interface 200 can display instructions on where the two customers can meet. In a particular example, user interface 200 can introduce two single customers who both like celery by displaying instructions to meet in the product section by the celery at a particular time.

In some embodiments, as shown in FIG. 2C, user interface 200 can be used to provide incentives to purchase gasoline at a retail store. For example, user interface 200 can provide a challenge to purchase an exact amount of gasoline in exchange for some type of reward. The customer's gasoline purchase history can be analyzed to determine an approximate amount of gas that is typically purchased by the customer. Also, user interface 200 can challenge the customer to purchase an exact amount of gasoline using a certain number of pumps (i.e. squeezes of the pump). Such challenges can provide a diversion to an otherwise mundane task.

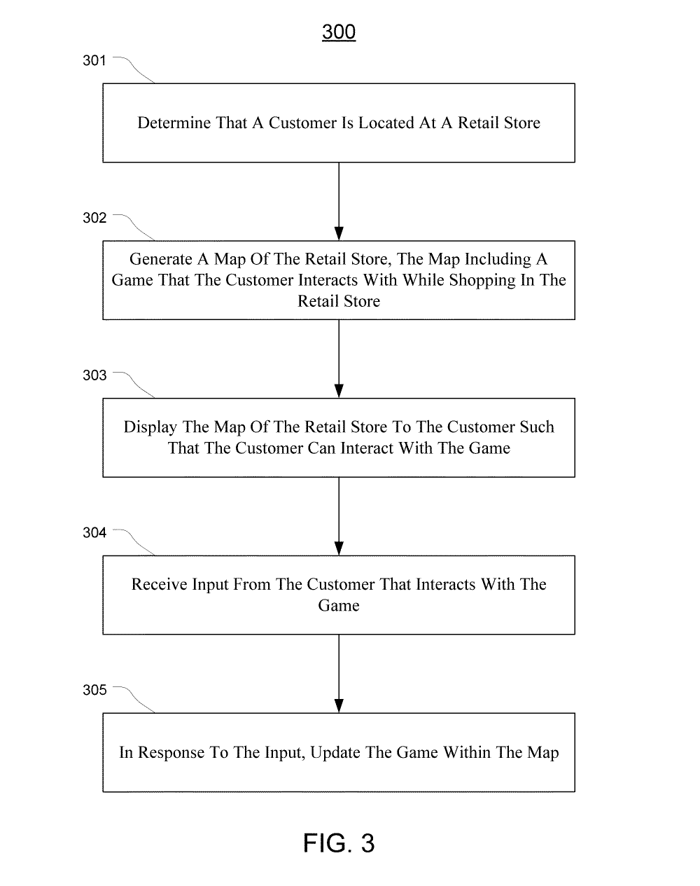

FIG. 3 illustrates a flowchart of an exemplary method 300 for providing a game within a map of a retail store to provide entertainment to the customer while shopping in the retail store. Method 300 can be implemented by a portable computing device such as a smart phone or other device having a display that is carried by the customer.

Method 300 includes an act 301 of determining, by the portable computing device, that a customer is located at a retail store. For example, customer computing device 102a can determine that the customer is located at a retail store such as by using GPS coordinates, receiving a signal transmitted from a device within the retail store, receiving customer input, etc.

Method 300 includes an act 302 of generating a map of the retail store, the map including a game that the customer interacts with while shopping in the retail store. For example, a map of the retail store can be generated on customer computing device 102a and displayed within user interface 200.

Method 300 includes an act 303 of displaying the map of the retail store to the customer such that the customer can interact with the game. For example, user interface 200 can display the map with the game to customer 201.

Method 300 includes an act 304 of receiving input from the customer that interacts with the game. For example, user interface 200 can receive input from customer 201 that interacts with the game.

Method 300 includes an act 305 of, in response to the input, updating the game within the map. For example, user interface 200 can update the game displayed with the map in response to customer 201′s interaction with the game.

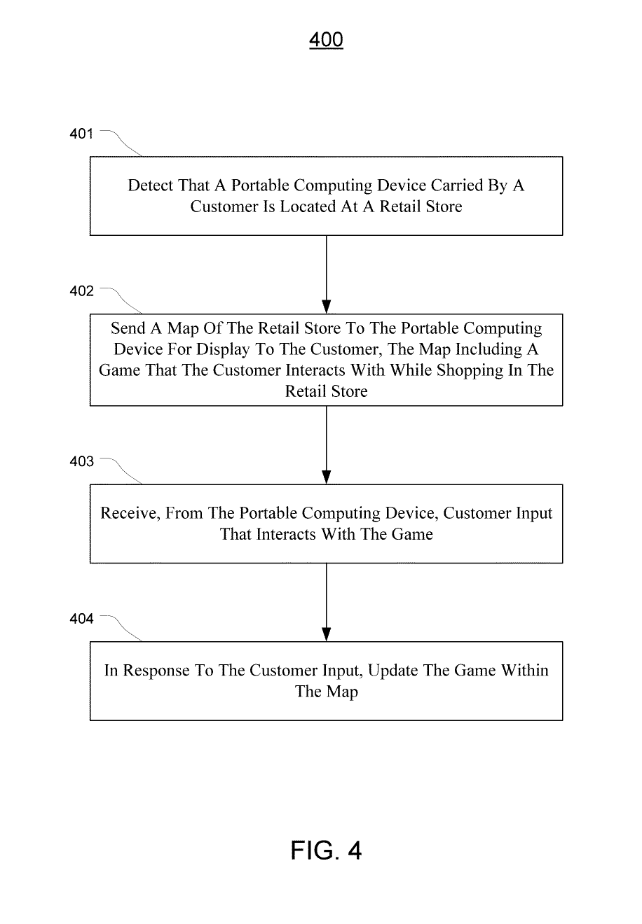

FIG. 4 illustrates a flowchart of an exemplary method 400 for providing a game within a map of a retail store to provide entertainment to the customer while shopping in the retail store. Method 400 can be performed by server system 101 or another computer system that can communicate with a customer's portable computing device.

Method 400 includes an act 401 of detecting that a portable computing device carried by a customer is located at a retail store. For example, server system 101 can receive a signal or other input from customer computing device 102a that identifies that customer computing device 102a is at a retail store.

Method 400 includes an act 402 of sending a map of the retail store to the portable computing device for display to the customer, the map including a game that the customer interacts with while shopping in the retail store. For example, server system 101 can send a map to customer computing device 102a that includes a game that the customer can interact with while in the retail store.

Method 400 includes an act 403 of receiving, from the portable computing device, customer input that interacts with the game. For example, server system 101 can receive customer input that was received via user interface 200 being displayed on customer computing device 102a.

Method 400 includes an act 404 of, in response to the customer input, updating the game within the map. For example, server system 101 can update the map in response to customer 201's interactions with the game.

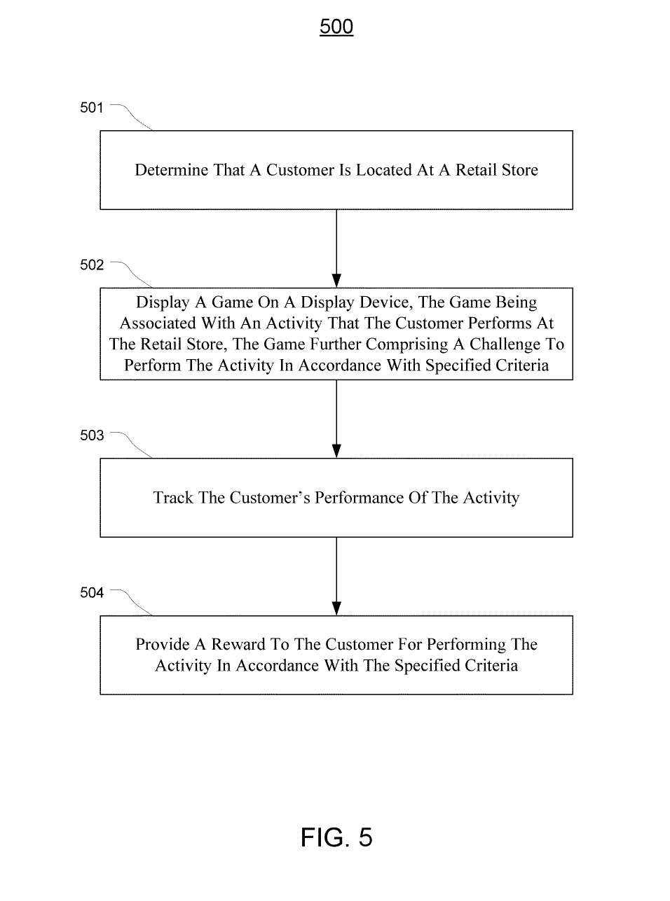

FIG. 5 illustrates a flowchart of an exemplary method 500 for providing a game to a customer while the customer is at a retail store. Method 500 can be performed by server system 101, another computer system or display device that can communicate with server system 101, or by a customer's portable computing device.

Method 500 includes an act 501 of determining that a customer is located at a retail store. For example, server system 101, customer computing device 102a, or another computer system can determine that a customer is located at a retail store by receiving input from the customer, detecting a signal transmitted by or to a computing device carried by the customer, etc.

Method 500 includes an act 502 of displaying a game on a display device, the game being associated with an activity that the customer performs at the retail store, the game further comprising a challenge to perform the activity in accordance with specified criteria. For example, a game can be displayed on a display device located at the retail store or a display of customer computing device 102a. The game can challenge the customer to perform an activity at the retail store such as pumping gas, going to a particular location, viewing a particular advertisement or product, etc.

Method 500 includes an act 503 of tracking the customer's performance of the activity. For example, one or more computer systems (e.g. server system 101, customer computing device 102a, a computing system in a gas pump, a display device located near a store, etc.) can be used to track the customer's performance of the activity.

Method 500 includes an act 504 of providing a reward to the customer for performing the activity in accordance with the specified criteria. For example, a reward such as a coupon, points, awards, etc. can be provided to the customer when the customer performs the activity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a portable computing device carried by a customer, for providing a game within a map of a retail store to provide entertainment to the customer while shopping in the retail store, the method comprising:
determining, by the portable computing device, that a customer is located at a retail store;
generating a map of the retail store, the map including a game that the customer interacts with while shopping in the retail store;
displaying the map of the retail store to the customer such that the customer can interact with the game;
receiving input from the customer that interacts with the game; and
in response to the input, updating the game within the map.

2. The method of claim 1, wherein the portable computing device comprises the customer's smart phone.

3. The method of claim 1, wherein determining that the customer is located at the retail store comprises one or more of:
using GPS coordinates to determine the location; or
receiving a signal from a device located within the retail store.

4. The method of claim 4, wherein the map comprises a floor plan of the retail store that includes aisles and shelves.

5. The method of claim 1, wherein the game comprises a challenge to traverse a particular route in the retail store.

6. The method of claim 1, wherein the game comprises displaying one or more activities that are to be performed at a particular location within the retail store.

7. The method of claim 6, wherein the one or more activities comprise a flash mob.

8. The method of claim 6, wherein the one or more activities comprise answering questions regarding the retail store or one or more products available in the retail store.

9. The method of claim 6, wherein the particular location where the one or more activities are to be performed is determined based on a current location of the customer within the retail store.

10. The method of claim 1, further comprising;
providing rewards to the customer when the customer completes an activity in the game.

11. The method of claim 1, further comprising:
outputting an audible or visual cue when the customer completes an activity in the game.

12. The method of claim 11, wherein the activity comprises purchasing a certain number or type of products.

13. A method, performed by a computer system, for providing a game within a map of a retail store to provide entertainment to the customer while shopping in the retail store, the method comprising:
detecting that a portable computing device carried by a customer is located at a retail store;
sending a map of the retail store to the portable computing device for display to the customer, the map including a game that the customer interacts with while shopping in the retail store;
receiving, from the portable computing device, customer input that interacts with the game; and
in response to the customer input, updating the game within the map.

14. The method of claim 13, wherein detecting that the portable computing device carried by the customer is located at the retail store comprises receiving a signal from the portable computing device that identifies the portable computing device.

15. The method of claim 13, wherein the game comprises displaying one or more activities that are to be performed at a particular location within the retail store.

16. The method of claim 15, wherein the one or more activities comprise answering questions regarding the retail store or one or more products available in the retail store.

17. The method of claim 15, further comprising:
outputting an audible or visual cue when the customer completes an activity in the game.

18. A method, performed by a computer system, for providing a game to a customer while the customer is at a retail store, the method comprising:
determining that a customer is located at a retail store;
displaying a game on a display device, the game being associated with an activity that the customer performs at the retail store, the game further comprising a challenge to perform the activity in accordance with specified criteria;
tracking the customer's performance of the activity; and
providing a reward to the customer for performing the activity in accordance with the specified criteria.

19. The method of claim 18, wherein the activity comprises pumping gas, and the specified criteria comprises pumping a specific amount of gasoline.

20. The method of claim 18, wherein the activity comprises meeting another customer, and the specified criteria comprises meeting the other customer at a specific location of the retail store.
